(19) United States
(12) Patent Application Publication
(10) Pub. No.: US 2017/0374088 A1
(43) Pub. Date: Dec. 28, 2017

(54) INDIVIDUALLY ASSIGNED SERVER ALIAS ADDRESS FOR CONTACTING A SERVER

(71) Applicant: Sable Networks, Inc., Santa Clara, CA (US)

(72) Inventors: Surya K. Pappu, Milpitas, CA (US); Kote Anumolu, Santa Clara, CA (US); Sanjay Oza, Cupertino, CA (US); Paul Jezioranski, Santa Clara, CA (US)

(21) Appl. No.: 15/627,807

(22) Filed: Jun. 20, 2017

Related U.S. Application Data
(60) Provisional application No. 62/353,541, filed on Jun. 22, 2016.

(51) Int. Cl. H04L 29/06; H04L 29/12

(52) U.S. Cl. CPC H04L 63/1416; H04L 63/1425; H04L 61/1511; H04L 61/2007; H04L 61/6018

(57) ABSTRACT

To mitigate attacks utilizing compromised DNS caches, a server gateway provides clients with unique IP addresses to contact the server. Packets sent to a server IP address from a particular client which are not linked to that particular with the server gateway are dropped. Thus, even if a client is compromised, the IP address for the server in the client's DNS cache cannot be used by other machines or virtual machines. With a one to one client to server IP address relationship, malicious actors cannot use numerous machines or virtual machines to overload the server with requests.

### CROSS REFERENCES TO RELATED APPLICATION

This patent application claims the benefit of U.S. Provisional Patent Application Ser. No. 62/353,541, filed on Jun. 22, 2016, and the subject matter thereof is incorporated herein by reference in its entirety.

### TECHNICAL FIELD

Teachings relate to mitigate malicious network behavior as between a server and client. Teaching more particularly relates to the assignment, use and management of server IP addresses assigned for use by a client for communication between the server and client.

### BACKGROUND

A common form of malicious network behavior is called Domain Name System (DNS) cache hijacking. DNS cache hijacking makes use of compromised DNS caches. A malicious actor accesses the DNS cache on a compromised client to obtain an Internet Protocol (IP) address used to communicate with a server. The IP addresses obtained are used for a variety of attacks on servers, most notably, directed denial of service (DDOS) attacks or denial of service (DOS) attacks. In a DDOS attack, the malicious actor uses the obtained server IP address from the compromised machine's DNS cache, and generates a multitude of malicious requests towards the server thereby, overloading the server. As a result, legitimate clients are prevented from communicating with the server.

Preventing or mitigating the style of network attacks that make use of a compromised client's DNS cache is therefore a useful endeavor.

### BRIEF DESCRIPTION OF THE DRAWINGS

FIG. 1 is an illustration of a generic prior art network;

FIG. 2 is an illustration of a network diagram with a client contacting a server according to various embodiments;

FIG. 3 is a flowchart illustrating a method of reassigning server addresses for network traffic;

FIG. 4A is an illustration of a network packet including a number of fields;

FIG. 4B is an illustration of a DNS packet including a number of fields;

FIG. 5 is an illustration of a network diagram with multiple gateways protecting a network according to various embodiments;

FIG. 6 is a sequenced block diagram for illustrating sequenced packet transmissions according to various embodiments;

FIG. 7 is a sample lookup table; and

FIG. 8 is a flowchart illustrating a time to live replacement address process.

### DETAILED DESCRIPTION

To mitigate attacks utilizing “compromised” DNS caches on the clients and to ensure that server requests from legitimate clients make it through, a server gateway provides clients with individualized IP addresses to contact a specific server. Packets sent to a server IP address (e.g., a specific mail server) from a particular client, using a server IP address not associated with the specific client, will be dropped at the server gateway. This ensures that packets from “compromised” clients (i.e., clients that have malicious software running with the intent of creating a server directed attack) that direct traffic to the specific server, using a server IP address that was “hijacked” from another client's DNS cache, will not reach the server.

Only packets to a server that use the specific server's IP address assigned by the server gateway, for use by a specific client, are accepted and forwarded by the server gateway to the server. With a one-to-one, client to server IP address relationship, malicious actors cannot use numerous machines or virtual machines to overload the server with requests. All such requests to reach the server are dropped right at the server gateway. Legitimate requests from clients make it through to the server when the one on one association of the client to the assigned server IP address is validated by the server gateway. In short, a vast pool of ‘alias’ IP addresses are created for each server and assigned to clients for use on a one-to-one basis. For example, the server alias address assigned for use by client A will be different from the server alias address assigned for use by client B—though both the clients are trying to communicate with the same server. When another client, client C, attempts to use the server IP address assigned to client B, client C's traffic is dropped, as it is most likely a malicious request/client.

This process relates to server address hiding. The purpose behind this process is two-fold—a), to hide the real address of the server from the client, which is often done with servers that could be easy targets of attack—and b) to further minimize the chances of an attack on the server by associating a one-to-one server IP address association with the client. While a simple address hiding by way of not using the real IP address of the server does protect the server to a certain extent, the server gateway (or a Layer 4 load balancer/gateway sitting in front of the server) may still be bombarded with malicious traffic using the server's “virtual” address from compromised clients.

Use of a “virtual address” may then create a situation, whereby, the server gateway is overloaded with traffic requests to the server. Since the server requests from compromised clients arrive at the server gateway using the valid “virtual” server IP address, they are forwarded to the server and would result in a server attack. The one-to-one association adds an additional layer of protection by validating whether the “virtual” server IP address used by a client is the one that the client has been assigned to use. This mechanism allows for differentiating server requests arriving at the gateway between legitimate clients and those requests from compromised clients. All such requests from compromised clients are dropped at the gateway. Often, this is performed by putting a gateway in front of the server, or an internal network upon which one or more servers and/or computers are present. The gateway then forwards traffic to the server/internal network and serves as an intermediary.

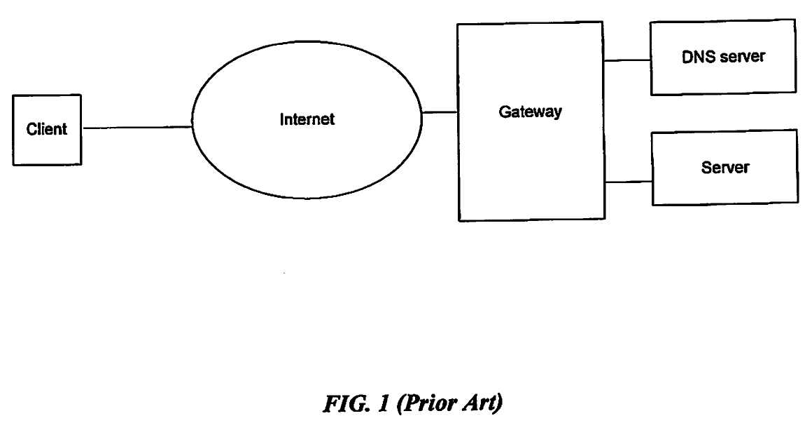

FIG. 1 is an illustration of a prior art network. All traffic and connections between the clients and the server terminate at the Layer 4 load balancer/gateway. This is because the VIP address used by the client belongs to the load balancer/gateway. The Layer4 load balancer/gateway, which acts as a proxy to the server, is tasked with establishing a connection between the Layer 4 proxy and the server, to forward all the traffic it receives from the clients, by performing address translation on a look up table. Since any of the clients can use any of the valid pool of VIP addresses for the server, all such traffic (using the server's VIP) is address translated and forwarded to the server. Likewise, in the reverse direction, all traffic from the server is address translated by replacing the server's real IP address with the server's VIP address at the load balancer/gateway, when forwarding traffic towards the client.

These Layer 4 load balancers/gateways, which act as a proxy for the server, may be overloaded. Since the only validation done by the Layer 4 gateway is the use of a valid VIP server address, the Layer 4 gateway has no other method to detect whether the requests for communicating with the server have come from a legitimate client or a compromised “attacking” client. The scenario where a client's DNS cache is hijacked to obtain a server's IP address (the server VIP as maintained in the client's DNS cache) by malicious software running on a different client is one where the attacker does not have to go through the DNS process. Instead, the attacker (from the compromised client) uses the “stolen” server VIP address to communicate with the server. Then the attacker may make several thousand or million requests to create a server directed attack.

The Layer 4 gateway, housed in front of the server does not distinguish these requests to be illegitimate since each uses the valid server's VIP address. Sophisticated behavior heuristics based approaches may be used by anti-DDoS devices/software to mitigate the effect of the attack; however, the server may still be overwhelmed with spurious traffic from attacking clients. Teachings herein go a step further than what Layer 4 load balancers/gateways/switches do, to thwart such ‘DNS Cache hijacking’ attacks.

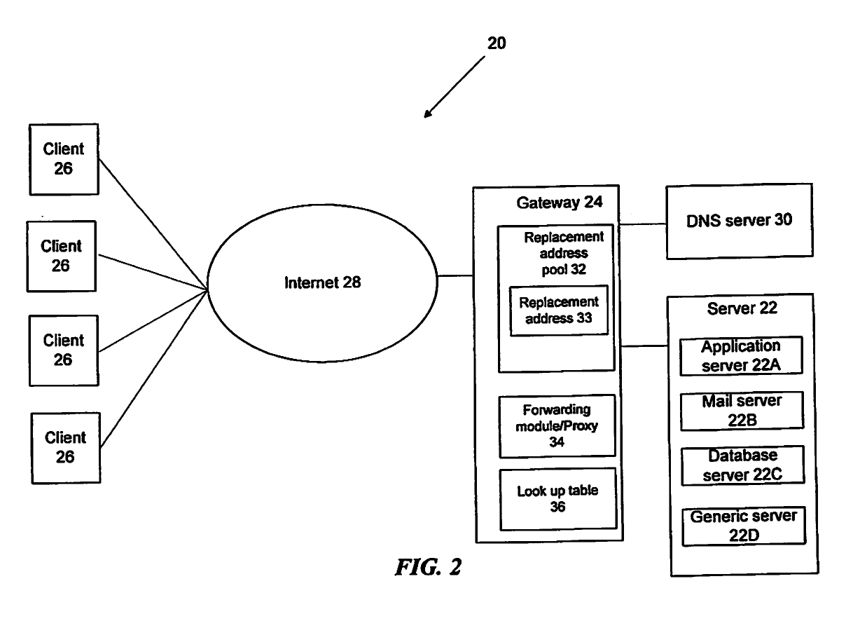

FIG. 2 is an illustrative block diagram of a network with a client contacting a server, according to various embodiments. A network 20 includes a server 22 which is located behind a gateway 24. The network further includes clients 26 that communicate with the server 22 through the gateway 24 across the Internet 28. In order to achieve this, the clients make DNS requests to a DNS server 30 to obtain an IP address to use to contact the server. The DNS request/response from the DNS Server 30 goes through the gateway in order to effect the one-to-one server to client address association process.

The server 22 refers to any type of server within an enterprise/corporation viz., FTP server, application servers, data storage servers, or other suitable servers known in the art. In another variation, the network 20 could represent the Intranet (i.e., internal corporate network) of an enterprise/corporation/organization. The server 22 may also comprise an internal server network. Examples include an application server 22A, a mail server 22B, a database server 22C, or another suitable class of server known in the art 22D. The DNS Server 30 is a local DNS Server 30 residing within the organization and the servers are the enterprise's servers. For this kind of network, there is always a possibility that there could be server directed attacks launched from outside.

In the corporation example, there exists a possibility that a client 26 from outside of the perimeter of the corporation is launching attacks. There may be malicious software running on a client 26 that malicious actors can implant.

For every server 22, there is usually a Fully Qualified Domain Name (FQDN) associated with it. Examples include the host name such as www.yahoo.com or bld06.corp.enterprise.com to represent specific servers within the organization. The server's host name is associated with a real IP address, and the server IP address to FQDN mapping is maintained by the DNS Server 30. The server's real IP address is not exposed to the clients. The most common approach that is taken to hide the server's real IP address from the clients is by the use of a Layer 4 load balancers/gateways 24 in front of the server 22. The real address is hidden and known only to the load balancer/gateway 24. The DNS Server's 30 FQDN to IP address mapping contains the Virtual IP address (VIP) 33 of the specific server. The VIP addresses 33 belong to the load balancer/gateway 24 and the clients are provided with the server's VIP during the DNS phase.

The gateway 24 in FIG. 2 and taught herein is a processor operated solution, which functions on a physical apparatus or as a virtual machine. The gateway 24 is architecturally located between the server 22 and the clients 26. Though pictured in FIG. 2 as a server side gateway, the gateway 24 may be architecturally closer to the clients 26. In some embodiments, the gateway 24 comprises a network of filtering devices which includes a number of gateways 24 which each serve a subset of the total set of clients 26. The only requirement in regards to the location of gateway 24 is that DNS responses (either from the local DNS Server or from a remote one) pass through such a gateway 24 in order to effect the one-to-one correspondence of server replacement/alias/virtual IP address and the client (for the purposes of this disclosure replacement, alias, and virtual IP addresses are interchangeable terms).

The gateway 24 further includes a vast pool of replacement/virtual IP addresses 32 containing virtual addresses 33 for use in editing the DNS response (to indicate the server address to use by the client for communication). The gateway 24 also includes a proxy or forwarding module 34 for establishing forwarding rules that establish the one to one correspondence between the client and the server virtual address assigned for use by this client, and a look up table 36 to compare with fields in received packets. The pool of virtual IP addresses 32 are used by the gateway 24 to provide a virtual address 33 for the server 22 to the clients 26. The forwarding module 34 generates forwarding rules for determining whether to accept or drop packets with an action of modifying the packet headers as needed (if the packet is accepted), based on specific combinations of the source and destination IP addresses. The look up table 36 is used to record pairings of IP addresses (server virtual address assigned for the specific client address) as assigned from the virtual IP address pool 32 by the forwarding module 34.

In some embodiments, each client 26 will get a different address with a certain time period for which the virtual address is valid. In some embodiments, there's a time to live (TTL) period established in the gateway 24 as also in the clients 26, that indicates the duration of validity of the client-server virtual address pairings such that the assigned virtual server address 33 is only valid for a relatively short time period, such as five minutes. After the expiry of the TTL period, clients need to remove the DNS entries for the specific server 22 from the DNS cache and issue a new DNS request for any new traffic to the specific server 22.

The size of the pool of replacement addresses 32 would vary based on expected traffic to a server 22, number of users of a particular server at any given instance of time, length of the “record's” TTL period, availability of “reachable” addresses that could be part of the pool of replacement addresses 32 and other administrative factors. In one possible scenario, 10,000 replacement addresses 33 may be sufficient. This assumes that there are never more than 10,000 unique users of a given server 22. In this example, while 10,000 virtual addresses 33 for 10,000 clients 26 is a physical limit, there are also reasons for having a greater number of replacement addresses 33 than clients 26.

There may also be cases where the number of available replacement addresses 33 in the pool 32 is much lower than the number of unique clients 26 (to the server 22). This usually happens when the available number of addresses to use is limited. In the case of an enterprise's private network, a vast pool of private addresses may be used to be part of the server address replacement pool 32. On the other hand, servers reachable via the Internet and managed by Internet or Cloud Service Providers may be limited in the number of “public” IP addresses that could be used as part of the server replacement address pool 32.

Both the number of addresses in the pool of replacement addresses 32, and the TTL period would be altered to fit the particular circumstances of the server 22. For example, if the server 22 is intended to manage a corporate web site upon which the average user visit was 2 minutes, the TTL period could be adjusted to match the average user visit. Further, the number of replacement addresses could be tailored to match the number of unique visitors expected during a predetermined time period (such as a day or a week).

Determining the exact TTL period is a tradeoff. If the period is too short, clients 26 will not appreciate the extra delay of issuing a DNS request and it affects the quality of experience of the user (in terms of the application such as a web page slowing down or loading very slow). Accordingly, the exact TTL expiry period is balanced against a variety of factors such as—how big a replacement address pool 32 is available, the traffic pattern to the specific server 22, the security aspects of the particular server 22, how often the address pool may be reused, etc. . .

Virtual addresses 33 in the replacement pool of addresses 32 are recycled. Accordingly, having shorter TTL periods is recommended. Virtual addresses that stay in the cache for time measured in hours have greater side effects. Once all the replacement addresses are used up for all the clients, any new DNS requests may be served in one of two ways—either drop all such requests and not allow any more new clients 26 to communicate with the server—or start re-using the pool of replacement/alias server addresses to the new clients. The former approach may result in legitimate clients being denied access to the server 22 until the clients 26 already communicating with the server 22 stop the communication. One beneficial aspect of this strategy is that any kind of attack from compromised clients is completely thwarted as the client to server virtual address mapping is truly one-to-one. The latter approach of re-using the virtual server addresses 33 for new clients 26 once the entire pool is used up for a set of clients 26 results in losing out on the fool-proof advantages of the one-to-one (unique server alias address to each client) mapping approach. There is a slight possibility whereby a virtual server address 33 loops around too quickly enough (with too many clients trying to contact the server) to be used by a malicious actor or a compromised client.

In some embodiments, where the alias address pool is not large enough, the server alias address assigned to each client 26 would not necessarily be unique, but rather would match those assigned to a particular small subset of clients 26. A possibility exists that a server directed attack may be started from a compromised client using a server (alias) address hijacked from another client's DNS cache. The attacker could also spoof the client's address in the attack. In this process, there is a slight possibility that the spoofed client's address may be associated with the “hijacked” server alias address because the server alias address has been reused—and such a combination may actually be considered valid by the gateway 24. The gateway 24 may have genuinely assigned the server alias address (that was hijacked) as part of the DNS process to a client (which happens to the spoofed address used by a compromised client). Such a case of mistaken identity may result in the “attacker's” traffic be treated as legitimate traffic by the gateway 24.

The probability that so many things fall in place (the attacker needs to use a spoofed client's address that is a valid client's address AND the server alias address hijacked happens to the one assigned for a client whose address has been spoofed) for a compromised client to initiate an attack is extremely small. This probability is completely driven by the size of the address pool 32 and the address re-use algorithm to make the address assignment unpredictable. In order to improve protection, ideally, there is no intentional relationship, or shared characteristics between clients 26 that share a virtual IP address.

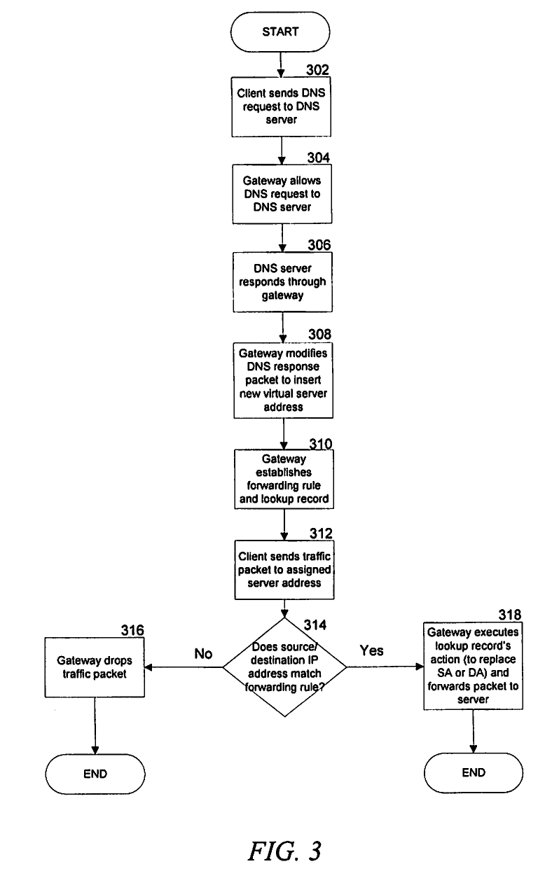

FIG. 3 is a flowchart illustrating a method of reassigning clients' destination addresses for network traffic. In step 302, a client 26 sends a DNS request seeking the address of a server to the DNS server 30. In step 304, the DNS request passes through the gateway 24 and is received at the DNS server 30. In step 306, the DNS server responds to the client 26 through the gateway 24.

In step 308, the gateway intercepts the DNS response packet and replaces the server IP address (for the server host name requested by the client in the DNS request) the DNS server has responded with, in the DNS response packet, with a virtual IP address. The virtual IP address comes from the pool of replacement addresses 32. Each of the replacement IP addresses available in the replacement IP address pool 32 correspond to the gateway 24, though, based on the address used and the client from which packets originate, the gateway 24 forwards or drops received packets from the client 26 (as per step 310).

In step 310, the gateway 24 establishes a forwarding rule with the forwarding module 34 to determine which packets from the client 26 can be sent to the server 22. The forwarding rule establishes that packets coming from a particular client (as identified by a source IP address of client 26) using the destination address as assigned from the replacement address pool 32 by the gateway 24 (in step 308) are to be forwarded to the server 22. The gateway 24 records the forwarding rule in a look up table 36. The rule will also have information on the “real” IP address of the server that needs to be placed in the packet prior to forwarding the traffic to the server. Likewise, a reverse direction (traffic from server 22 to client 26) forwarding rule will also be added to the lookup table 36 in this step. That rule indicates that for traffic coming from the server 22 using the server's “real” IP address going towards a specific client 26, the source address (which corresponds to the server 22) needs to be replaced with the replacement/virtual IP address assigned for that particular client's use.

The lookup table 36 includes records that match the client's address with the virtual IP address of the server assigned to that particular client. Depending on the direction of traffic flow, the client's address may correspond to the source or destination IP address in the packet. Likewise, depending on the traffic direction, the server's IP address would also correspond to either the destination or source IP address.

In step 312, the particular client sends traffic packets with the destination address being the assigned virtual IP address of the server. The packet is received by the gateway 24. In step 314, the gateway evaluates the received packet. The gateway 24 parses the packet for the source IP address and the destination IP address. The source address and destination address are compared to records in the lookup table 36. If there is no match, in step 316, the packet is merely dropped. If there is a match, in step 318, the gateway 24 forwards the packet to the server 22. Note that a record will exist if the specific client, sending traffic to the server, has been assigned a server alias address and the traffic seen at the gateway 24 uses that tuple combination (of source and destination addresses).

A distinction of this method from prior art is that the server's virtual IP address is unique for each client. Further, the forwarding rules created in the gateway 24 ensure that a client is allowed to contact the server only using the client assigned server virtual IP address for the server they would like to communicate with. Any other client trying to use a different client's assigned server virtual address will not be able to contact the server as the forwarding rules in the gateway 24 will drop all such traffic. Such a mechanism will provide for a foolproof mechanism to thwart DNS cache hijacking based server-directed attacks.

In prior art methods, a gateway has several available virtual IP addresses that are shared across the entire client base, and are each usable by all of the clients in order to contact the server located behind the gateway. Any compromised client that had access to a DNS cache with the server's virtual IP address will be able to communicate with the server thus ‘facilitating’ a server directed attack. Conversely, here, the server's alias/replacement addresses are not shareable across the entire client base. Instead, a specific server alias IP address assigned for use to a specific client, ensuring a one-to-one correspondence of address between the client and the server alias address used. Clients are, therefore, only able to use the server virtual IP addresses assigned to a particular given client.

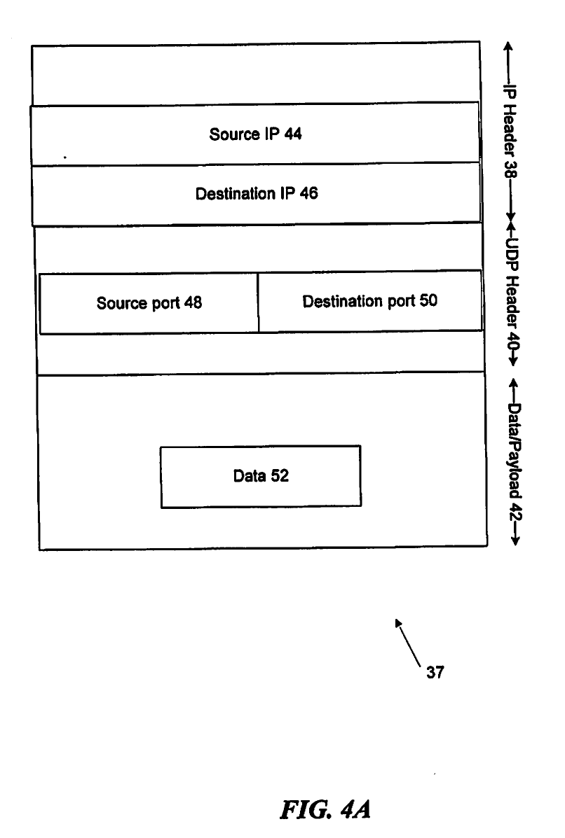

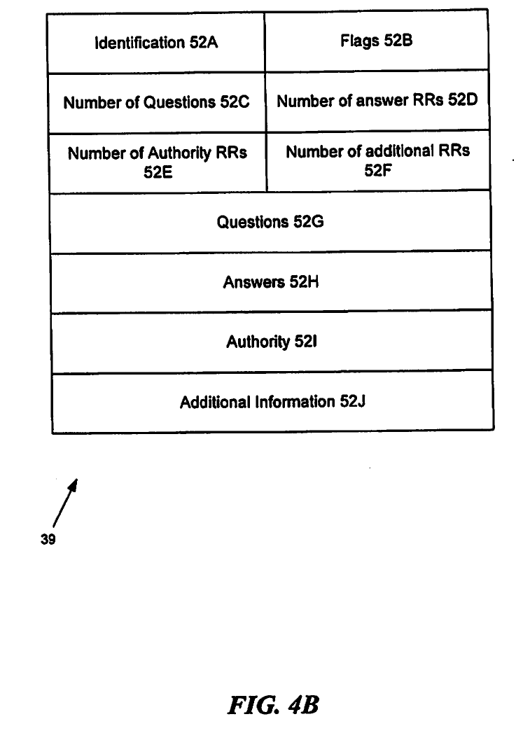

FIG. 4A is one possible illustration of a network packet including a number of fields. A packet 37 has a number of sections, an IP header 38, a user datagram protocol (UDP) or Transport Control Protocol (TCP) header 40 and a payload 42 section. Each of these sections have fields. The fields of the IP header 38 include the Source IP address 44, and the Destination IP address 46, among others. Packets 37 leaving the server 22 bound for the client 26 are edited in the gateway 24 to amend the source IP address 44 from the actual IP address of the server 22 to the alias server IP addresses assigned for the specific client 46. Thus, the receiving client never has access to the actual IP address of the server 22.

The UDP header 40 additionally has source and destination port fields 48, 50 among others. These would often remain unchanged, though in some embodiments, ports may also be amended by the gateway 24, as part of a specific type of Network Address Translation—Port Translation (NAT-PT), before the packet 37 reaches the client, The payload 42 includes data 52 transmitted between the clients 26 and the server 22.

FIG. 4B is an illustration of a DNS packet 39 including a number of fields. The DNS response packet is a control packet, different from regular “data” traffic. The DNS packet includes a header section as the network packet 37 does, and thus includes a source IP 44, destination IP 46, a source port 48 and a destination port 50 (each of these fields is redundant and therefore not pictured). The DNS data portion includes identification field 52A, a series of flags 52B, a number of questions 52C, a number of answer resource records 52D, a number of authority resource records 52E, and a number of additional resource records 52F.

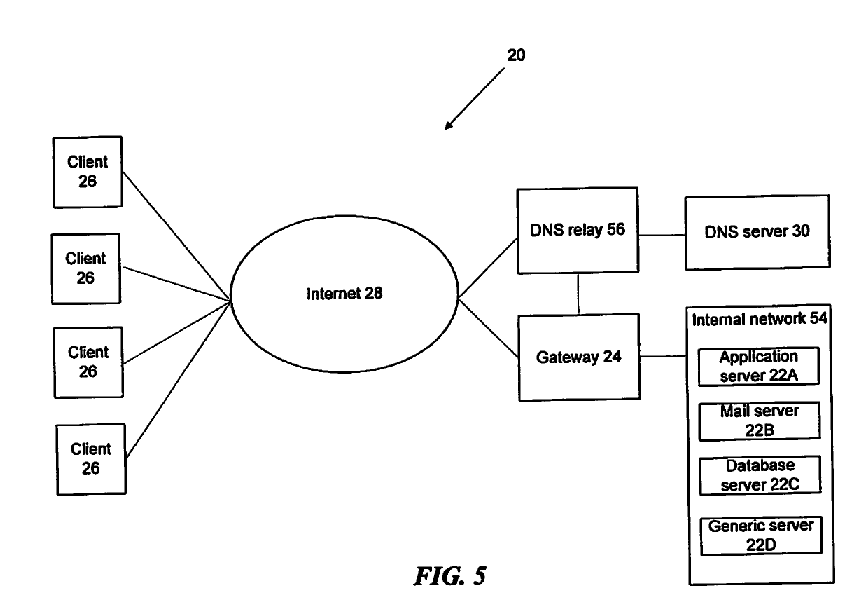

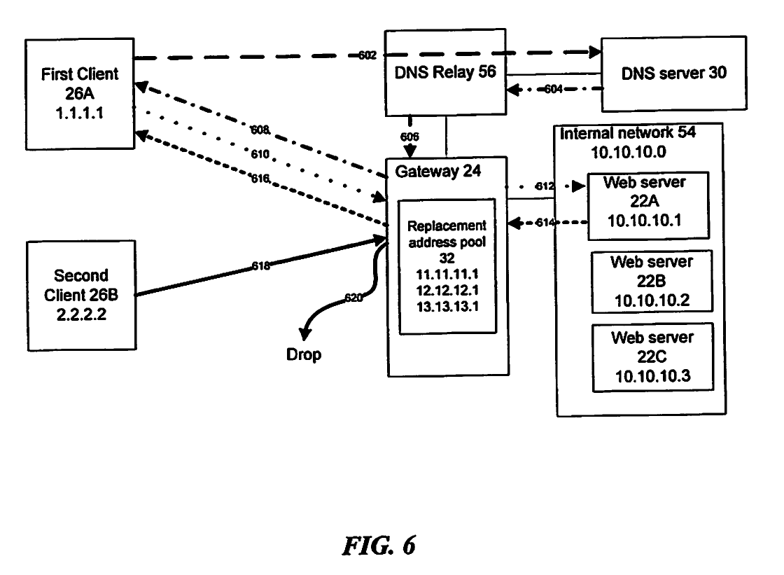

The “data” portion of the DNS response packet 39 then includes the indicated questions (name, type) 52G, resource record answers in response to queries 52H, records for authority servers 52I, and additional resource records 52J. Each of these fields has several sub-fields that are not shown here. The resource record answers 52D has a listing of the domain name to IP address mappings along with the time to live period indicating the duration for which the mapping is considered valid in the DNS cache of the clients The use of the DNS response packet 39 is further discussed in FIGS. 5 and 6.

FIG. 5 is an illustrative block diagram of another possible network scenario with a DNS relay 56 and a gateway 24 protecting an internal network 54 according to various embodiments. In this scenario, the gateway 24 performing address hiding/replacement sits closer to the internal server network 54; however, the DNS responses towards the clients 26 from either the local or remote DNS Servers 30 are not directly in the path of gateway 24. In order for the address replacement with a one-to-one correspondence between the client's address and the server's virtual address to take effect, the DNS responses are relayed from the relay agent 56 towards the gateway 24 performing the address hiding/replacement for the internal server network 54. The DNS relay 56 or snooping agent, snoops on DNS packets between clients 26 and the DNS server 30, parsing the DNS response. The request packet that goes from a client 26 to the DNS server 30 can be ignored. The DNS response contains a mapping of the host name—the Fully Qualified Domain Name (FQDN) to its IP address. If the FQDN happens to be one among those that need to be relayed to gateway 24, it is redirected to that gateway.

FIG. 6 is a block diagram illustrating the sequence of packet transmissions according to various embodiments. Displayed are elements of FIG. 5 with the addition of packet transmission sequence events. The network design in FIG. 6 shows a scenario whereby the DNS relay functionality 56 runs on a separate gateway from the gateway 24 that runs the server address hiding and enforces the forwarding rules. In this particular instance, gateway 24 is located near the internal server network 54. Other embodiments may have the gateway 24 connected in some form to both the internal network 54 and to the DNS Server 30 (local or a remote one connected to this gateway). Still others may have the gateway 24 running the server address hiding steps, being located closer to the clients 26. The configuration of elements may vary according to any other figure disclosed herein. As long as the DNS response is relayed through gateway 24 that operates the server address hiding algorithm, any variations to the network design in different embodiments are possible.

In step 602, a first client 26A sends a DNS request to the DNS server 30 to obtain the IP address of a server 22A in the server network 54. For example, let us say the first client 26A has an IP address of 1.1.1.1 and the server 22A in the internal network 54 is referred to, using its FQDN/hostname www.abcd.com. The first client 26A requests the IP address of server 22A (hostname: www.abcd.com) of the internal network 54, from the DNS Server 30 by providing its hostname.

In step 604, the DNS server 30 sends a DNS response packet, with the server's 22A host name to IP address mapping, towards the client 26A. The DNS response packet is received by the DNS relay gateway 56. The DNS response packet includes the actual or virtual IP address of the server 22A, which for example, is 10.10.10.1. Configuration at the DNS Relay 56 would indicate that DNS response packets for any of the servers belonging to the internal network 54 (i.e., from the domain name of *.abcd.com) will need to be relayed to gateway 24.

In step 606, the DNS relay 56 snoops the DNS response packet and since the response payload has the server's IP address for the *.abcd.com's domain (which was configured on the DNS relay 56 to match for, and relay the response to gateway 24), the packet is forwarded to gateway 24 for address replacement.

Once the gateway 24 receives the relayed DNS response packet from DNS relay 56, the server address hiding processing begins. The forwarding module 34 in gateway 24, selects a virtual address 33 from the virtual address pool 32 to use for server 22A (10.10.10.1) for the specific client 26A (1.1.1.1). Assume that the forwarding module 34 selects 11.11.11.1 as the virtual address for the server 22A. The forwarding rule module creates a detailed record in the look up table 36 (see FIG. 2).

Gateway 24 generates a record in the look up table 36 (see FIG. 2) that associates the first client's IP address, 1.1.1.1 with the virtual server address, 11.11.11.1, and associates the record to the actual address (or virtual address as seen in the DNS Server 30 for the hostname www.abcd.com) of the server 22A, 10.10.10.1. In some embodiments, each such record in the look up table has a “Time to Live” (TTL) period that indicates the time period for which the association is valid. The association with the virtual address is deleted once the TTL period expires. This corresponds to the client's DNS cache aging out the entry for www.abcd.com and it's association to the address 11.11.11.1.

In step 608, the gateway 24 edits the DNS response packet to remove the actual address of the server 22A from the data portion 52 (see FIG. 4B) of the DNS response packet, and replace it with the virtual address, 11.11.11.1, assigned by the forwarding module 34. The DNS response packet is then delivered to the first client 26A. Thus, the first client 26A, has never had access to the actual server IP address (10.10.10.1). In some embodiments, the DNS response packet additionally includes details concerning a TTL period and provides instructions to the first client to delete the provided IP address (in this case, 11.11.11.1) from the first client's DNS cache after the expiration of the TTL period (via the DNS packet's record expiry timer field).

Once the first client 26A (1.1.1.1) obtains the address of the server 22A, it communicates with it. In step 610, the first client 26A sends data traffic packets with a source address of 1.1.1.1 and a destination address of 11.11.11.1. This packet reaches the gateway 24. The gateway 24 evaluates this traffic packet using the lookup table 36. Checking the IP header 38 (see FIG. 4A) of the traffic packet, the gateway 24 determines if a record exists for source IP 44/ destination IP 46 combination of 1.1.1.1/11.11.11.1 in the lookup table 36. The existence of a record for the source IP+destination IP address combination indicates that the gateway 24 would accept this packet and replace the destination IP address to that of the server's real IP address.

In step 612, as a result of a match in the lookup table 36, the traffic packet is forwarded to the actual IP address of the server 22A by replacing the destination IP address with that of the server's real IP address. In this example, a match in the lookup table 36 for the entry corresponding to source IP 1.1.1.1 and destination IP address of 11.11.11.1 will yield a lookup action to replace the destination IP address with 10.10.10.1—the real address of the server 22A. The gateway 24 modifies the traffic packet corresponding to the desired server 22A's IP address in the internal network 54, as indicated by the record in the lookup table 36. Here, the destination IP 46 is edited from 11.11.11.1 to 10.10.10.1 and the traffic packet is delivered to the server 22A. In step 614, the server 22A responds with a response data traffic packet that is delivered to the gateway 24 towards the first client 26A.

In step 616, the gateway 24 amends the response traffic packet before sending the response data packet to the first client 26A. In the reverse direction, the source IP address would correspond to that of the server's 22A address. Using the lookup table 36, a match found for the source address of server 22A and destination address of client 26A will result in the gateway amending the source IP 44 of the traffic response packet from the actual address 10.10.10.1 to the selected virtual address 11.11.11.1. Accordingly, the first client 26A still never has access to the actual address of the server 22A (10.10.10.1). Communication between the first client 26A and the server 22A proceeds in the same fashion of steps 610-616, repeatedly, as necessary.

In some embodiments, where a TTL period is used, once the timer expires for the first client 26A, the first client 26A deletes the virtual address 33 to host name mapping from the local DNS cache, and the process for communication begins anew at step 602. In a second iteration of the process, the gateway 24 may select the virtual address 33 as 12.12.12.1 for the first client 26A. The first client 26A would then proceed using the 12.12.12.1 address to contact the server 22A. The virtual addresses 33 cycles through, though not necessarily in numerical or any other order. Instead, the virtual addresses 33 may be selected randomly, or according to a suitable algorithm known in the art. The size of the pool of virtual addresses available for use by the gateway 24, is inversely related to the chance for a specific virtual address to be re-used for other clients that would like to communicate with the same server 22A. In this way, other clients that need to communicate with the server 22A are assigned other replacement/virtual addresses (13.13.13.1, etc.) despite the fact that all these clients are trying to reach the same server 22A. This is how a one-to-one correspondence is (via the lookup tables) created with the assignment of a server's alias address to a specific client.

To demonstrate a failed process, a second client 26B is introduced. The second client 26B has an example IP address of 2.2.2.2. By some means, either malicious or innocent, in step 618, the second client 26B attempts to transmit packets to a server 22 in the internal network 54 using the destination IP 46, 11.11.11.1. The second client's packets are received by the gateway 24.

In step 620, the gateway 24 undertakes a similar process as in step 610-612, except this time there is no match in the lookup table 36. There is no record for the source/destination tuple combination of source IP 44, 2.2.2.2, and destination IP 46, 11.11.11.1 to accept the packet. If this client had gone through a DNS process, the Gateway 24 would have created an association entry for the client's address 2.2.2.2 with an assigned alias server address that will be different from 11.11.11.1. Since an entry is not found in the lookup table for this tuple combination, the packet from the second client 26B is dropped.

In a further hypothetical scenario, if the second client 26B performs a DNS request and goes through steps 602-608, the gateway 24 would assign another virtual address 33, such as 13.13.13.1 and generate a record in the lookup table 36 for the second client 26B associating the virtual address 13.13.13.1 with 2.2.2.2. Such a record indicates that any packet from 2.2.2.2 to the server 22A would have to arrive at the gateway 24 with a destination address of 13.13.13.1, since that is the assigned server virtual address for use by this client 26B. In short, a record in the lookup table is created with the allowed tuple combination (of source and destination addresses) for both the forward and reverse direction (i.e., to and from the server). The action from the lookup, when a match is found, is to replace the source IP address or the destination IP address (depending on the traffic direction), as appropriate, to use either the real address or the alias address of the server 22A.

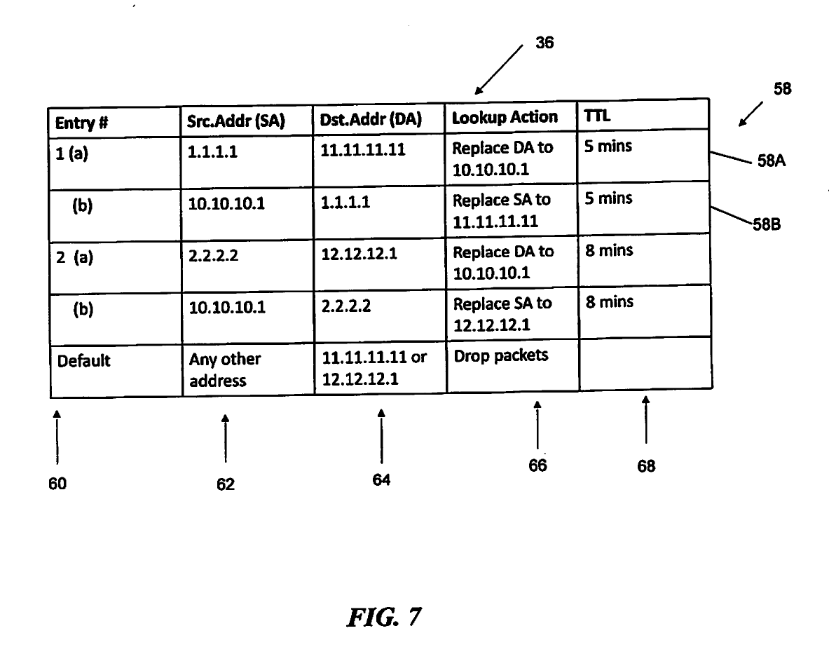

FIG. 7 is a sample lookup table 36. Look up tables 36 would include records 58. Records include a number of data fields 60-68. Each record 58 includes sub-entries 58A, 58B for the forward and reverse directions, respectively. The data fields include a reference number 60 for a given record 58, a source address field 62, a destination address field 64, a lookup action field 66, and a record time-to-live timer 68. In use, the gateway will compare data fields 62 and 64 of available records 58 with fields source IP 44 and destination IP 46 of incoming and outgoing packets 37. A match will result in the lookup action 66 being executed (A no-match may have a default action of drop to indicate that specific server alias addresses have not be assigned to the client and so, such traffic is not permitted). The time to live timer 68 for the specific entry matched, will also be used to determine when to “age out” (i.e., delete) the lookup record. The displayed lookup table 36 is illustrative for a sample, though this particular configuration or implementation is not necessary to perform systems and methods taught herein.

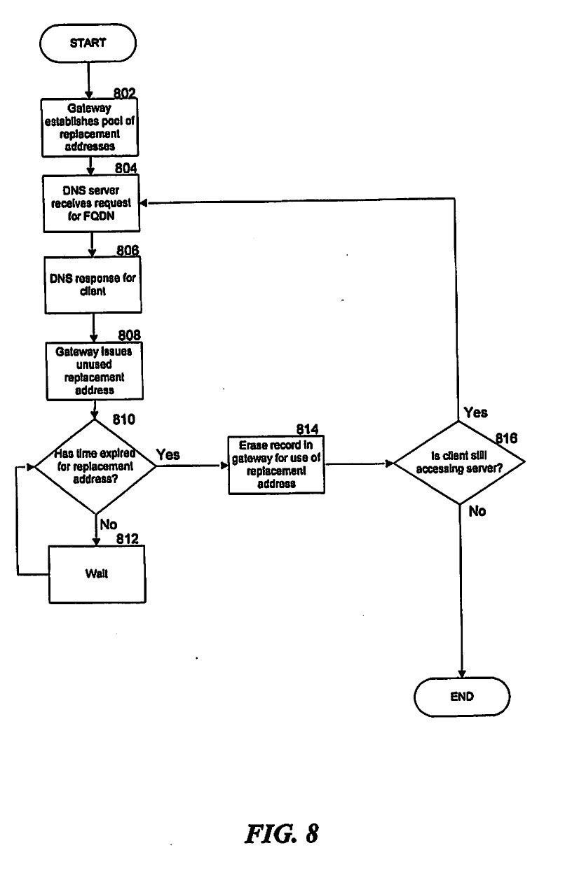

FIG. 8 is a flowchart illustrating the virtual address aging out process. Since the pool of addresses available for use is always finite, a mechanism for aging out assigned but unused virtual addresses is required. In step 802, the gateway establishes a pool of IP addresses used to contact the server. The virtual addresses are inserted into packets transmitted to and from the servers shown in FIG. 6.

In step 804, a DNS server receives a request from a client to map the FQDN for a server to an IP address. In step 806, the DNS server begins to send a response back to the client, the DNS response is snooped and passed through to the gateway.

In step 808, the gateway issues an unused virtual address to the client for the desired server. Packets sent between the client and this server are edited to remove the actual IP address of the server and replace it with the virtual address assigned by the gateway. The use of an assigned server virtual address for a specific client is time dependent, and after a predetermined period of time, the issuance expires. This ensures that the virtual address is returned to the free pool of replacement addresses for assignment to other clients. Note that the expiry of the timer will result in deletion of the specific records in the gateway while a similar timer at the client will purge out the entry from the DNS cache.

The “time period” for which the entry is kept active may be determined either via configuration, by use of the DNS record's TTL field (that indicates how long the specific DNS record in the DNS response is valid), or by keeping track of the usage of specific records in the lookup table (indicated by the amount of traffic referring to the specific record in question). In step 810, there is a check to see if the timer has expired or not. If the time has yet to run, in step 812, the system waits. If the period of time has run, in step 814, the corresponding record in the gateway which has the client virtual address tuple is deleted. While the gateway may keep a history of which replacement addresses were previously issued to a given client, the present record created using the client address and the assigned virtual address tuple is removed.

Once the record of the specific client address and server virtual address tuple is removed from the lookup table, if the client wishes to communicate with the server as in step 816, then it will re-initiate the entire DNS Server request process starting from step 804. The process returns to step 804, and the client makes an additional DNS request. If not, the process ends.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this patent application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

1. A method for preventing DDOS attacks on a network originating through DNS snooping techniques by assigning rotating IP addresses to particular network clients and dropping packets received at assigned IP addresses which do not come from the corresponding assigned clients, the method comprising:
establishing, at a gateway, a pool of available IP addresses, the IP addresses for contacting a network behind the gateway, wherein packets to and from the network are routed first through the gateway;
receiving a DNS query for the network at a DNS server from a client, the client having a client IP address;
providing, to the client, an assigned IP address from the pool of available Internet Protocol addresses for a predetermined period of time, the assigned IP address usable by the client as a destination address for packets delivered by the client in order to communicate with the network through the gateway;
temporarily pairing the assigned IP address to the client IP address of the client in a lookup table, wherein after the predetermined period of time has elapsed the assigned IP address and the client IP address are unpaired in the lookup table;
receiving a first packet at the gateway, the first packet having a first source address and a first destination address, wherein the assigned IP address is the first destination address of the first packet; and
evaluating whether or not the first source address of the first IP packet is the client IP address paired with the assigned IP address in the lookup table,
wherein when the client IP address and the first source address of the first packet do not match, the gateway drops the first packet.

2. The method of claim 1, further comprising:
transmitting, by the gateway, response packets from the network to the first source address of the first packet, the response packets having response source addresses, and wherein the gateway replaces the response source addresses in the response packets from the network with the assigned IP address.

3. The method of claim 1, wherein the gateway includes a first gateway and a second gateway, the first gateway positioned in front of a domain name system server associated with the network, and the second gateway positioned in front of the remainder of the network and including a domain name system relay, such that the first gateway performs said providing an assign Internet protocol address step, the method further comprising:
packet snooping, by the second gateway of packets transmitted by the first gateway to the client in order to parse the transmitted packets for the client address and assigned Internet protocol address.

4. A method for preventing network attacks, comprising:
establishing, at a gateway, a pool of available Internet protocol addresses associated with contacting a network behind the gateway, wherein packets to and from the network are routed first through the gateway;
receiving a query for a network address at a DNS server from a client, the client having a client address;
providing, to the client, an assigned Internet protocol address from the pool of available Internet Protocol addresses;
pairing the assigned Internet protocol address to the client address in a lookup table;
receiving a first packet at the gateway using the assigned Internet protocol address; and
delivering said first packet to the network via the gateway only if the first packet originated from the client address.

5. The method of claim 4, further comprising:
removing the pairing between the assigned Internet protocol address and the client address after a predetermined amount of time.

6. The method of claim 5, wherein each Internet protocol address in the pool of Internet protocol addresses are assigned to a plurality of clients in rotation such that upon said removing the pairing and assignment, the assigned Internet protocol address is available for reassignment to an additional client address.

7. The method of claim 4, further comprising:
screening the client for malicious behavior; and
preventing connection between the network and malicious clients.

8. The method of claim 4, further comprising:
amending, at the gateway, response packets from the network intended for delivery to the client such that a value for a source address of each response packet is amended to the assigned internet protocol address; and
transmitting amended response packets from the gateway to the client.

9. The method of claim 4, wherein the gateway has a physical network position which is either near the network, or near a network of clients.

10. The method of claim 4, wherein undelivered packets are dropped by the gateway.

11. The method of claim 4, wherein domain name system packets associated with the network are all routed through the gateway.

12. The method of claim 11, wherein the gateway includes a first gateway and a second gateway, the first gateway positioned in front of a domain name system server associated with the network and including a domain name system relay, and the second gateway positioned in front of the remainder of the network and, such that the second gateway performs said providing an assigned Internet protocol address step, the method further comprising:
packet snooping, by the first gateway of packets transmitted by the DNS server to the client in order to parse the transmitted packets for the client address and assigned Internet protocol address.

13. The method of claim 12, the packet snooping step further comprising:
obtaining a host name and matching the host name to a server within the network in order to forward packets received by the second gateway to the server.

14. A system for preventing network attacks, comprising:
a computer network;
a DNS server configured to receive queries for a network address from a client, the client having a client address;
a gateway to the network including a pool of Internet protocol addresses that enable external clients to communicate with the network via the gateway wherein packets to and from the network are routed first through the gateway, the gateway configured to:
intercept DNS response packets transmitted to the client from the DNS server; provide to the client, an assigned Internet protocol address from the pool of available Internet protocol addresses;
a lookup table maintained by the gateway wherein the assigned Internet protocol address is paired to the client address; and
wherein packets received at the gateway using the assigned Internet protocol address are delivered only if the request originated from the client address.

15. The system of claim 14, wherein the pairing between the assigned Internet protocol address and the client address is removed after a predetermined amount of time.

16. The system of claim 15, wherein each Internet protocol address in the pool of Internet protocol addresses is assigned to a plurality of clients in rotation such that upon said removing the pairing and assignment, the assigned Internet protocol address is available for reassignment to an additional client address.

17. The system of claim 14, wherein the gateway screens the client for malicious behavior and prevents connections between the network and malicious clients.

18. The system of claim 14, wherein the gateway amends response packets from the network intended for delivery to the client such that a value for a source address of each response packet is amended to the assigned interne protocol address prior to transmission from the gateway to the client.

19. The system of claim 14, wherein the gateway has a physical network position which is either near the network, or near a network of clients.

20. The system of claim 14, wherein undelivered packets are dropped by the gateway.

21. The system of claim 14, wherein domain name system packets associated with the network are all routed through the gateway or a DNS relay.

22. The method of claim 21, wherein the gateway includes a first gateway and a second gateway, the first gateway positioned in front of a domain name system server associated with the network and including a domain name system relay, and the second gateway positioned in front of the remainder of the network and, such that the second gateway performs said providing an assigned Internet protocol address step, wherein the first gateway snoops packets transmitted by the DNS server to the client in order to parse the transmitted packets for the client address and assigned Internet protocol address.

23. The system of claim 22, wherein the gateway snoops packets and obtains a host name and matching the host name to a server within the network in order to forward packets received by either the first gateway or the second gateway to the server.
